(19) United States
(12) Patent Application Publication
(10) Pub. No.: US 2023/0038267 A1
(43) Pub. Date: Feb. 9, 2023

(54) SYSTEMS AND METHODS FOR PROVIDING OSCILLATORY MOTION TO AN INDIVIDUAL

(71) Applicant: INNAWAVE INC, Los Angeles, CA (US)

(72) Inventors: Steve Patrick STONE, Los Angeles, CA (US); Eric Richard PELTOLA, Los Angeles, CA (US)

(73) Assignee: INNAWAVE INC, Los Angeles, CA (US)

(21) Appl. No.: 17/791,928

(22) PCT Filed: Feb. 18, 2021
(86) PCT No.: PCT/US21/18612

§ 371 Date: Jul. 11, 2022

Related U.S. Application Data
(60) Provisional application No. 62/978,774, filed on Feb. 19, 2020.

(51) Int. Cl. A61H 1/00; A61H 1/02

(52) U.S. Cl. CPC A61H 1/005; A61H 1/0266; A61H 2201/5061; A61H 2201/5007; A61H 2230/00; A61H 2201/149

(57) ABSTRACT

A medical device for providing oscillatory motion to an individual is provided. The medical device includes a holder that can hold one or more body parts of an individual and an oscillatory mechanism that can transmit an oscillating force to the holder. The medical device includes one or more sensors that provide information about the individual and one or more compliant components that are configured to allow movement of the one or more body parts that deviates from a movement of oscillation. The oscillating mechanism can dynamically change a frequency of an oscillation based on feedback from the one or more sensors. The oscillating mechanism can also dynamically change an amplitude of the oscillation based on feedback from the one or more sensors.

### CROSS REFERENCES TO RELATED APPLICATIONS

This application claims the benefit of U.S. Provisional Patent Application. No. 62/978,774, entitled as “Systems And Methods For Providing Oscillatory Motion To An Individual”, filed Feb. 19, 2020, which is incorporated by reference in its entirety.

### FIELD OF THE INVENTION

This disclosure relates to a medical device that transmits reciprocating motion to an individual.

### BACKGROUND

There are many physiological processes, such as breathing and heartbeat, that follow a regular periodic pattern. Such physiological processes often respond to oscillatory stimulation. Human health practitioners have long applied reciprocating pressure and motion to various body parts to provide positive physiological results. Other forms of reciprocating motion are known to stimulate physiological results. For example, it has long been known that gentle rocking will soothe a baby. In another example, the heart has been shown to respond to oscillatory motion. Enhanced external counter pulsation is a technique for treating angina by compressing the extremities in an oscillatory rhythm that matches the heartbeat. In another example, it has been shown that high frequency oscillatory ventilation in preterm infants can prevent lung injury.

Automated devices and systems, however efficient, often do not match the touch and versatility of a human practitioner. The human practitioner may adjust the frequency or the pressure of a reciprocating motion to a patient based on various feedback from the patient. There is a need in the art for better systems of transmitting oscillatory motion to an individual to induce physiological effects including reduction of pain and inflammation, enhancement of the immune system, and stimulating a parasympathetic nervous system response. There is a further need in the art for a device that mimics the touch and versatility of the human practitioner.

### SUMMARY

The present disclosure includes a medical device for providing reciprocating motion to an individual. In an exemplary embodiment, the medical device includes a holder that can hold one or more body parts of an individual and an oscillating mechanism that can transmit an oscillating force to the holder. The medical device includes one or more sensors that provide information about the individual and one or more compliant components that are configured to allow movement of the one or more body parts that deviates from a movement of oscillation. The oscillating mechanism can dynamically change a frequency of an oscillation based on feedback from the one or more sensors. The oscillating mechanism can dynamically change an amplitude of the oscillation based on feedback from the one or more sensors. The one or more compliant components may be configured to allow the one or more body parts to deviate from a motion of oscillation in a direction that is perpendicular to the movement of oscillation. At least one of the one or more compliant components may include one or more rods that connect the holder to the oscillating mechanism where the one or more rods are flexible. The oscillating mechanism may be configured to adjust the frequency of oscillation of the oscillating mechanism to an optimal frequency of the individual based on feedback. The feedback from the one or more sensors may be a force of a contact between the individual and the oscillating mechanism where the oscillating mechanism is configured to adjust the frequency of oscillation to the optimal frequency of the individual by minimizing the force of the contact between the individual and the oscillating mechanism. The feedback may include one or more physiological measurements of the individual from one or more medical sensors. At least one of the one or more compliant components may include a heel holder that is shaped to apply pressure to a heel of the one or two feet and allow the one or two feet to freely rotate about the ankles of the one or two feet.

In an exemplary embodiment, the medical device includes a pad that is shaped to rest against one or more body parts of an individual and one or more sensors that provide information about the individual. The medical device includes an oscillating mechanism that can transmit an oscillating force to the pad as the oscillating mechanism oscillates. The oscillating mechanism may automatically adjust a frequency of oscillation. The oscillating mechanism may automatically adjust the amplitude of oscillation. The oscillating mechanism may be configured to adjust the frequency of oscillation to minimize a force feedback from the one or more sensors. The oscillating mechanism may automatically adjust the amplitude of oscillation to maintain a contact with the individual as the oscillating mechanism oscillates. The pad may be further shaped to support the heel portion of one or two feet where the pad allows the one or two feet to rotate about the ankles freely while the one or two feet are supported by the pad. The medical device may further include one or more compliant rods that connect the holder to the oscillating mechanism where the one or more compliant rods are configured to allow the feet to deviate from a movement of oscillation. The oscillating mechanism may be a linear actuator that includes a force feedback sensor. The medical device may further include one or more medical sensors that measure a physiological response in the individual.

Another general aspect is a method of providing reciprocating movement to an individual. The method includes oscillating, by an oscillating mechanism, a pad that is in contact with a body part of an individual where the oscillating mechanism can dynamically change a frequency of the oscillating based on feedback from one or more sensors embedded in a device, which provide information about the individual. The oscillating mechanism can dynamically change an amplitude of the oscillating based on the feedback. The pad is configured to allow the body part a limited movement in a direction that deviates from a direction of the oscillating. The pad may be further configured to support one or two feet of the individual. A force that is transmitted from the oscillating mechanism may be directed in a direction from the one or two feet of the individual through the center of mass of the individual. The oscillating mechanism may be configured to adjust the frequency of the oscillating of the oscillating mechanism to an optimal frequency of the individual based on the feedback. The feedback may include one or more physiological measurements of the individual from one or more medical sensors. The feedback may further include a force of a contact between the individual and the oscillating mechanism where the oscillating mechanism is configured to adjust the frequency of the oscillating to a natural frequency of the individual by minimizing the force of the contact between the individual and the oscillating mechanism. The oscillating mechanism may be further configured to further adjust the frequency of oscillation from the natural frequency to the optimal frequency based on the one or more physiological measurements where a holder is shaped to apply pressure to the heels of the one or two feet and allow the one or two feet to freely rotate about ankles of the one or two feet.

### BRIEF DESCRIPTION OF THE DRAWINGS

FIG. 1 is a schematic of a reciprocating medical device illustrating the components that may be used in an embodiment of the disclosed subject matter.

FIG. 2 is a schematic of an oscillating mechanism for the reciprocating medical device.

FIG. 3 is an illustration of a holder for the reciprocating medical device.

FIG. 4 is an illustration of interstitial fluid in between cells in tissue.

FIG. 5 is an illustration of interconnectivity of interstitial fluid with capillary blood vessels and a lymphatic system.

FIG. 6 is an illustration of a lymphatic system in an individual.

FIG. 7A is a flow diagram for a process of providing reciprocating movement to an individual.

FIG. 7B is a flow diagram for a process of adjusting the reciprocating movement to an optimal frequency of the individual.

FIG. 8 is an illustration of a foot of an individual resting in the holder of the reciprocating medical device.

FIG. 9 is an illustration of an embodiment of the holder of the reciprocating medical device that holds two feet.

FIG. 10 is an illustration of a reciprocating medical device that can transfer reciprocating movement to an individual.

FIG. 11 is a block diagram of a computer system that may be implemented in the various embodiments of the controller for the reciprocating medical device.

### DETAILED DESCRIPTION

The disclosed subject matter describes a device that transfers reciprocating movement to an individual. The reciprocating movement, in some cases, may effectuate a physiological response in the individual. The reciprocating movement of a skilled human practitioner generally provides excellent physiological results. One goal of the reciprocating medical device is to accurately replicate the motion of the skilled human practitioner to achieve optimal physiological results. Another goal of the reciprocating medical device is to achieve precise reciprocating movement that is beyond the ability of the skilled human practitioner. The reciprocating medical device may make subtle adjustments to the amplitude, frequency and vectors of reciprocal motion based on feedback that is sensed by the reciprocating medical device.

Various factors that may describe how one patient moves differently from another patient include the mass of the individual, the amplitude of oscillation, and the frequency of oscillation. The reciprocating medical device may adjust its motion based on those factors. The reciprocating device may be portable such that it can sit at the foot of a bed as an individual lies in the bed with the heels of the individual resting in foot holders that are attached to the reciprocating medical device by compliant rods.

The reciprocating medical device may oscillate the holder such that gentle pushing oscillations are transmitted to the individual. In each pushing oscillation, the holder is extruded and the individual is gently pushed in a direction from the foot to the center of mass or the head such that the head of the individual moves from about 0-2.5 cm. In various embodiments, the range of motion may be larger than 2.5 cm. For instance, the range of motion may be from 0-3.0 cm or 0-3.5 cm. The reciprocating medical device may be configured to adjust the range based on the individual patient and the patient's condition. For example, the reciprocating medical device may be set to a low frequency and a low range of motion for a patient that is in a fragile condition such as just out of surgery.

Clinical evidence suggests that use of the reciprocating medical device has a profound effect on inflammation and changes the way blood clotting factors work. Placement of the reciprocating medical device and adjustment for frequency and amplitude of motion may be dependent on location of a wound or surgery on mucosal tissue. In various cases, blood vessels may be closer to the surface such that they need to be treated differently to avoid bleeding.

After the holder is extruded, it is retracted and the individual returns to the original position of the individual. In various embodiments, the holder may be configured to only push the individual. In an exemplary embodiment, the holder is configured to push and pull the individual. In an exemplary embodiment, the holder is configured to only pull the individual. The individual may return to the original position because the portions of the skin of the individual maintain contact with a surface that the individual is lying on as the individual is gently pushed such that the individual does not slide. Thus, the individual returns to the original position of the individual when the holder is retracted.

The frequency of the oscillations and the amplitude of the oscillations in the reciprocating medical device may be adjusted. In various embodiments, the frequency and/or amplitude are automatically adjusted to match an optimal frequency of the individual. In some cases, the optimal frequency of the individual is a frequency of motion of the individual that requires the least force to maintain. In other cases, the best results may be achieved by deviating from the frequency that requires the least force to maintain. In an exemplary embodiment, the reciprocating medical device may sense a frequency that requires the least force to maintain and use this to establish a base frequency at which the body moves naturally at a given amplitude of movement. The reciprocating medical device may then deviate from the base frequency to deliver optimal physiological results.

The reciprocating medical device may be configured to automatically adjust the frequency of oscillations to the optimal frequency of the individual based on feedback from sensors embedded in the device, which provide information about the motion of the individual. Sensors may also provide information based on a physiological response in the individual. For example, the sensors may measure heart rate or blood oxygen level. Sensors may measure an amount of swelling in an area of the body.

Like frequency, the amplitude of oscillations may be adjusted to match a natural range of motion of the individual. The natural range of motion may be defined in various ways. In one embodiment, the natural range of motion is a length that an individual may be comfortably pushed without sliding. Like the frequency of oscillations, the reciprocating medical device may automatically adjust the amplitude of oscillations based on the feedback. The feedback may be a force that the individual pushes back against the reciprocating medical device such as the force of contact between the holder and the individual.

In various embodiments, factors other than a natural range of motion may be used to set the amplitude, frequency, and vector of motion. The factors may include input from an operator of the reciprocating medical device regarding the patient's condition. The patient's preferences may also be factors in the settings for the amplitude, frequency, and vector of motion.

Factors that may influence the amplitude of motion may include the mass of the individual, friction of the surface on which the individual rests, and the desired frequency of motion. In an exemplary embodiment, a variable (V) is determined for an individual based on the equation 1, V=F^{α}A^{β}M^{γ}, where V is determined to be the product of frequency (F), amplitude (A) and mass (M) of the individual. The constant exponents, α, β, and γ, may be determined through experiment. Once a natural amplitude and frequency are determined, the amplitude and frequency may be adjusted based on the exemplary equation 1.

The holder of the reciprocating medical device may be shaped such that a body part may comfortably rest in the holder while maintaining significant freedom of motion. In one embodiment of the holder, the holder is shaped to allow the heel of the individual to rest in the holder. The holder may include one or more compliant components that allow the foot to freely move about as reciprocating force is transmitted to the foot. In an exemplary embodiment, the foot is not restrained in the holder and the foot may freely rotate about the ankle while reciprocating motion is transmitted to the individual. In various embodiments, the compliant rods may flex to allow the foot a limited freedom of movement.

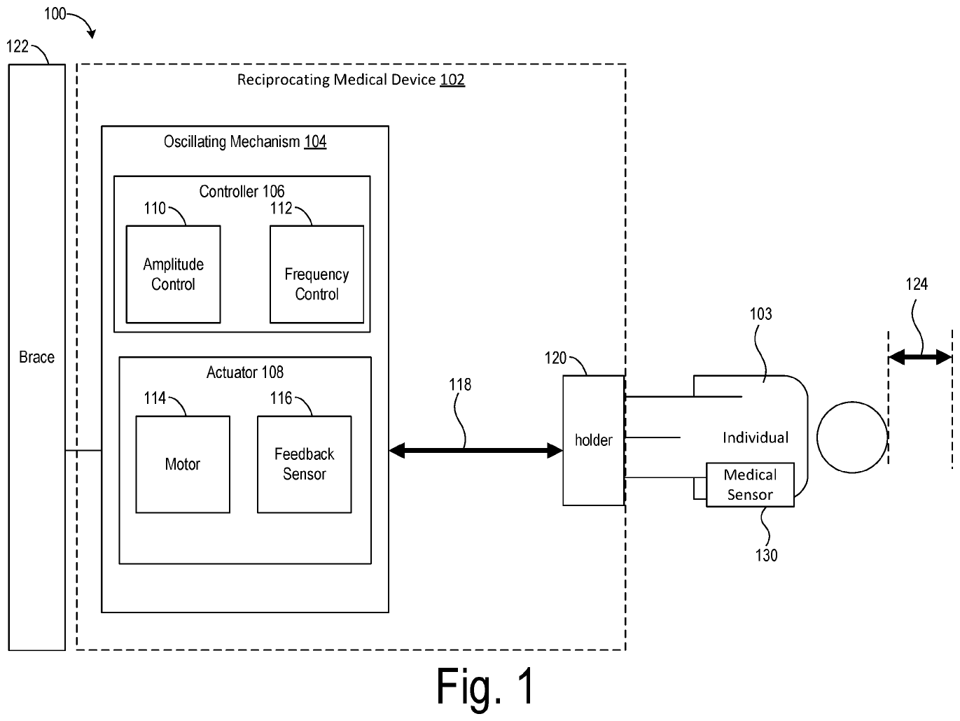

Referring to FIG. 1, FIG. 1 is a schematic 100 of a reciprocating medical device 102 illustrating the components that may be used in an embodiment of the disclosed subject matter. The reciprocating medical device 102 may be used to provide therapy to an individual 103 that is similar to the therapy of a human practitioner that is massaging a patient. A human practitioner may adjust the frequency and range of motion of the massage based on the feedback from the sensors. Similarly, the human practitioner may shift positions to allow the individual 103 a free range of movement.

Like the human practitioner, the reciprocating medical device 102 adjusts to the individual 103 based on the feedback from the sensors. The reciprocating medical device 102 may adjust a frequency of oscillation and an amplitude of oscillation. The reciprocating medical device may allow the individual 103 relative freedom of movement by allowing the ankles of the individual 103 to rotate freely as the reciprocating medical device 102 holds the heels of the individual 103. Flexible compliant rods may also allow the feet of an individual a limited freedom of movement.

The reciprocating medical device 102 includes an oscillating mechanism 104 and a holder 120. The oscillating mechanism 104 creates reciprocating motion 124 that is transferred to the individual 103. The oscillating mechanism 104 may have control of the frequency and amplitude of the reciprocating motion 124. The oscillating mechanism 104 may receive feedback such that the oscillating mechanism 104 can adjust the frequency and/or amplitude of reciprocating motion 124 based on the feedback.

The oscillating mechanism 104 may include a controller 106 and an actuator 108. The controller 106 is a computer system that is capable of sending instructions that, when executed, control the reciprocating motion 124 of the oscillating mechanism 104. The controller 106 may be a single computer system, an internet of things device, a co-located computer, a cloud based computer, or the like. The controller 106 may include an amplitude control module 110 and a frequency control module 112.

The amplitude control module 110 determines the amplitude of the reciprocating motion 124 that is produced by the oscillating mechanism 104. The amplitude control module 110 may be configured to adjust the amplitude of the reciprocating motion 124 based on feedback from the sensors. Various criteria may be used by the amplitude control module 110 to determine an amplitude. The amplitude of the reciprocating motion 124 may be sectioned into a crest and a trough. The crest is the furthest point that the oscillating mechanism 104 may push an individual 103. The trough is opposite the crest and exists at the point at which the oscillating mechanism 104 retracts the furthest away from the individual 103.

In various embodiments, the amplitude control module 110 may set the crest and the trough based on feedback from sensors embedded in the device, which provide information about the motion of the individual 103 and/or a physiological response in the individual. In one embodiment, the feedback is a force that the individual 103 exerts against the reciprocating medical device 102. In various embodiments, the feedback is a physiological measurement of the individual such as a sensor that measures inflammation in an individual. In an exemplary embodiment, the amplitude control module 110 may be configured to set a crest such that the force exerted by the individual 103 against the reciprocating medical device 102 on a forward stroke stays below a maximum force. The amplitude control module 110 may be configured to set the trough such that the force exerted by the individual 103 stays above a minimum force. In various embodiments, the amplitude control module 110 may be configured to set the crest and trough based on measurements other than the force exerted by the individual. In an exemplary embodiment, after setting the crest and trough based on the force exerted by the individual 103, the amplitude control module 110 may further adjust the crest and trough based on sensors that measure a physiological response from the individual. Examples of sensors that measure a physiological response may be a thermometer or a respiration sensor.

The frequency control module 112 determines the frequency of the reciprocating motion 124 of the oscillating mechanism 104. The frequency control module 112 may be configured to set the frequency of oscillation based on feedback from the sensors. Various forms of feedback may be used by the frequency control module 112 to determine a frequency. In one embodiment, the frequency control module 112, like the amplitude control module 110, may determine a frequency based on a force that the individual 103 pushes against the reciprocating medical device 102. The frequency control module 112 may set a frequency such that the least force is exerted by the individual 103 over a cycle of the oscillating mechanism 104. In various embodiments, the frequency control module 112 may determine a frequency other than a frequency of least force/resistance. In one example, the frequency control module may determine a frequency of least force/resistance and then modify the frequency based on a physiological response from the individual. For instance, the frequency control module 112 may receive physiological measurements from an individual. An example of physiological measurements may be a heart rate, respiration rate, and blood oxygen level of the individual. In various embodiments, the frequency control module 112 may receive measurements that are correlated to inflammation in an individual. An example of a measurement that is correlated to inflammation may be a color sensor that transmits a color of an inflamed area of skin. The frequency control module 112 adjust a frequency to maximize a beneficial physiological response or minimize a detrimental physiological response. For example, the frequency may be adjusted to reduce inflammation in an individual 103.

The actuator 108 creates reciprocating motion 124 in the oscillating mechanism 104. The actuator 108 may have a motor 114 and a feedback sensor 116. The motor 114 may be various machines that convert any form of energy into mechanical energy. In various embodiments, the motor 114 is a servo motor with precise control over the position of output generated by the motor 114. The actuator 108 may be connected to the holder 120 through an actuator rod 118. The actuator 108 moves the holder 120 in a reciprocating motion 124 based on the amplitude and frequency that is set by the controller 106.

The feedback sensor 116 senses feedback forces based on the interaction between the holder 120 and the individual 103. Data measured by the feedback sensor 116 may be transmitted to the controller 106 to determine the optimal amplitude and frequency of reciprocating motion 124. The feedback sensor 116 may collect various forms of data based on the interaction between the holder 120 and the individual 103.

In one embodiment, the feedback sensor 116 may measure the force that is exerted by the holder 120 against the individual 103. In various embodiments, the feedback sensor 116 may measure the force exerted by the holder against the individual 103 by a force gauge. The force measured by the force gauge may be used by the amplitude control module 110 and the frequency control module 112. In one example the amplitude control module 110 sets the trough at the position of the actuator 108 at which the feedback sensor measures 116 a minimum force. Likewise, the amplitude control module 110 may set the crest at the position of the actuator 108 at which the feedback sensor measures a maximum force. The minimum and maximum forces may be manually or automatically determined. In various embodiments, the feedback sensor may be a current sensor that measures the current, and thus the torque exerted by the motor 114. The torque exerted by the motor 114 is directly proportional to the force exerted by the holder 120 against the individual 103.

The holder 120 is the part of the reciprocating medical device 102 that contacts the individual 103. The reciprocating motion 124 that is created by the actuator 108 is transmitted through the actuator rod 118 to the holder 120, which transmits the reciprocating motion 124 to the individual 103. In various embodiments, the feedback sensor 116 may be embedded in the holder 120. In various embodiments, the feedback sensor 116 may be embedded in the actuator 108 or the actuator rod 118. In one embodiment, the holder 120 may be shaped such that the holder 120 may transmit the reciprocating motion 124 by pushing, but not pulling the individual 103. In an exemplary embodiment, the holder 120 may be configured to pull and push the individual 103.

In one embodiment, the holder 120 is shaped to hold one or two feet of the individual 103. The shape of the holder 120 may allow the one or two feet of the individual 103 to rest in the holder 120 while being free to rotate about the ankles. The freedom of movement may allow the individual 103 to be comfortable and thus gain the most benefit from the reciprocating motion 124. If the individual 103 shifts position, as the holder 120 may allow, the controller 106 of the oscillating mechanism 104 may adjust the frequency and amplitude based on the new position of the individual 103. The reciprocating medical device 102 may be further configured to allow the feet of the individual to freely translate as well as rotate as oscillating motion is transmitted to the feet.

In various embodiments, the reciprocating medical device 102 may require a brace 122 placed opposite the individual 103 to stabilize the reciprocating medical device 102 as the reciprocating motion 124 is transmitted to the individual 103. As the reciprocating medical device 102 may be light and portable in various embodiments, there is a need for the brace 122 to keep the reciprocating medical device 102 stationary while in operation. The brace 122 may be various objects that are strong and/or heavy enough to remain stationary as the actuator 108 pushes against the individual 103.

In various embodiments, the reciprocating medical device 102 may include a medical sensor 130. The medical sensor 130 may be configured to detect various physiological measurements in the individual 103. Examples of medical sensors include, but are not limited to, a heart rate sensor, a respiration sensor, a blood oxygen level sensor, a thermometer, and a perspiration sensor. In an exemplary embodiment, the medical sensor 130 may measure indicators of inflammation. For instance, the medical sensor 130 may include a camera that is configured to measure the inflammation in an area of the individual 103. The camera may measure inflammation by recognizing indicators of inflammation such as swelling and color change. In one example, the controller 106 may process the camera images, or the camera may include a controller to process images, with a machine learned algorithm to recognize inflammation. The machine learned algorithm may be taught by various machine learning algorithms such as a neural network. The machine learning algorithm may use training images of inflamed body parts to train the machine learned algorithm to recognize inflammation in the individual 103.

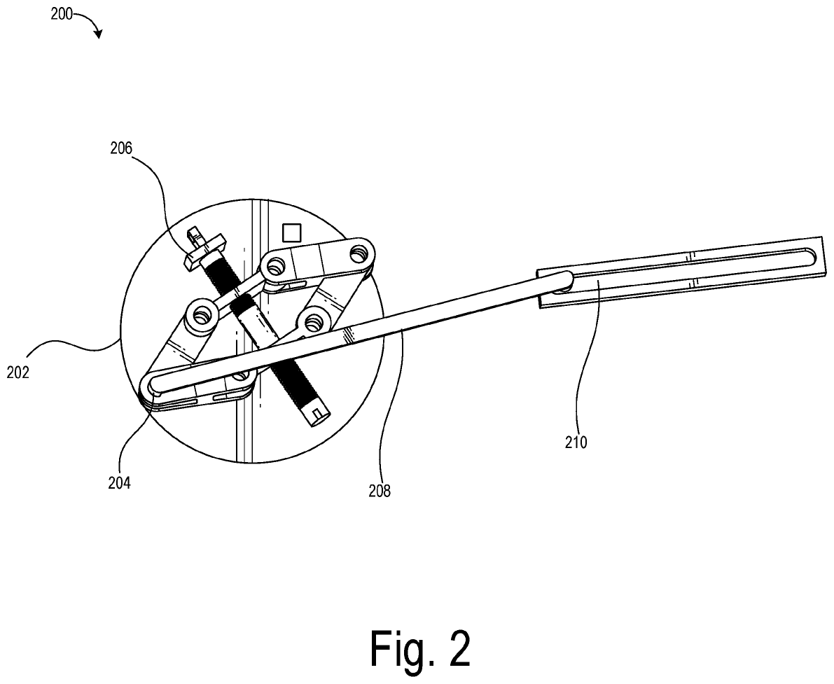

Referring to FIG. 2, FIG. 2 is a schematic of an oscillating mechanism 200 for the reciprocating medical device 102. The oscillating mechanism 200 may be various mechanisms that can transmit motion to an individual 103. The motor 114 of the oscillating mechanism 200 may be of various types including electric, gas powered, pneumatic, and hydraulic. In one embodiment, shown in FIG. 2, the oscillating mechanism 200 converts rotational motion into linear motion.

The motor 114 rotates a rotor 202. The rotor 202 may be various sizes. In one embodiment where the rotor 202 is configured to rotate in full circles to create the reciprocating motion 124, the radius of the rotor 202 may determine the amplitude of the reciprocating motion 124. As the rotor 202 is rotated by the motor 114, a rotary joint 204 may connect the rotor 202 to the actuator rod 208. The actuator rod 208 may be guided by a slide 210 that fixes one end of the actuator rod 208 to travel in a linear path. The radius at which the rotary joint 204 rotates about the rotor 202 may determine the amplitude of the reciprocating motion 124 if the rotor 202 rotates in full circles. In various embodiments, the motor 114 is a servo motor with fine control over the position of rotation of the rotor 202. The servo motor may be configured to oscillate back and forth in less than complete circles, which creates the reciprocating motion 124. The amplitude for the servo motor may be based on the start position and the end position of the rotor 202 as the motor 114 oscillates between start and end positions.

The oscillating mechanism 200 may have a radius adjustment component 206 that can modify the radius of the rotary joint 204. In various embodiments, the rotor 202 is rotated in full circles in one direction to create the reciprocating motion 124. The radius adjustment component 206 may adjust the amplitude of the oscillation by changing the radius of the rotary joint 204. The frequency may be adjusted by modifying the speed of rotation of the rotor 202. In various embodiments, the reciprocating motion 124 is created by precise back and forth motion of a servo rotor. The frequency is determined by the rate at which the back and forth motion is created by the servo motor.

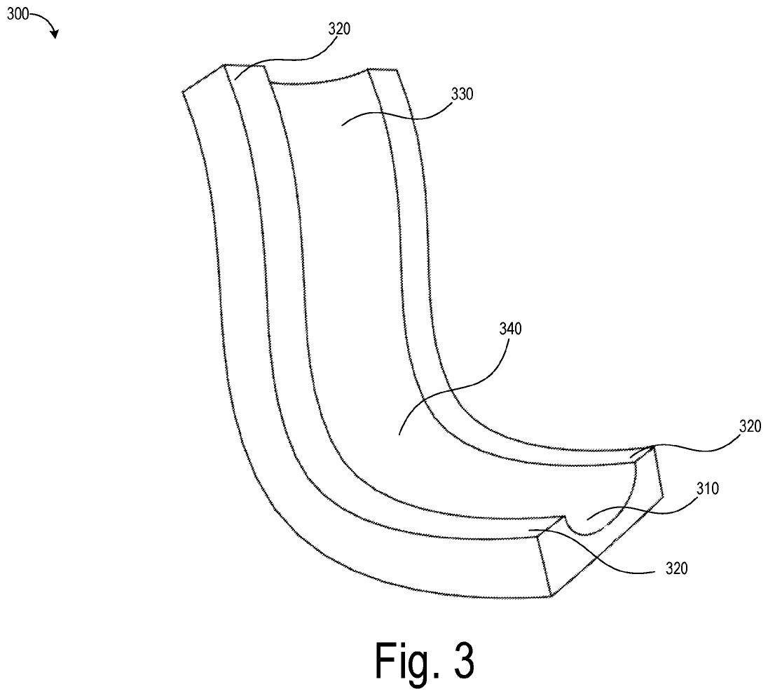

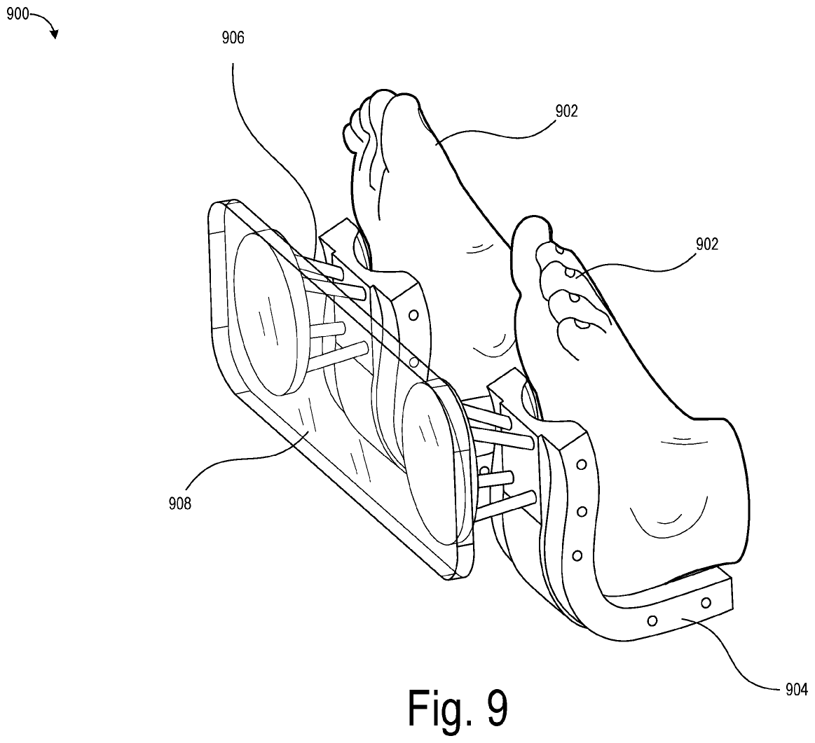

Referring to FIG. 3, FIG. 3 is an illustration of a holder 300 for the reciprocating medical device 102. The holder 300 may be shaped to hold or support various body parts. The holder 300 shown in FIG. 3 is shaped to support the heel of a foot. In various embodiments, the holder 300 may be shaped to support other body parts such as a hand, the head, and a shoulder. Multiple holders 300 may be used together in one reciprocating medical device 102. The illustration shown in FIG. 9 shows two holders 300 being used in one reciprocating medical device 102.

In the embodiment shown in FIG. 3, the holder 300 is shaped to allow the heel of a foot to rest in a heel-rest 310 which has a quarter-pipe shape. A pair of ridges 320 are elevated above the heel-rest 310. The pair of ridges 320 and heel-rest 310 provide support for the heel of a foot while allowing the foot to rotate about the ankle. The pair of ridges 320 line the side of the holder 300 that faces the foot as the heel rests in the heel-rest 310. The pair of ridges 320 do not completely envelope the side of the foot, which allows the foot to have free lateral movement.

The heel-rest 310 provides support for the heel of the foot against the force of gravity as the heel rests in the holder. A curved heel stop 340 portion of the holder 300 curves such that it provides support against the force of gravity and transmits the reciprocating motion 124 from the reciprocating medical device 102. The reciprocating medical device 102 transmits the reciprocating motion 124 in the foot to a center-of-mass of the individual 103 direction. The bottom of the curved heel stop 340 portion supports the heel against gravity while an upper part of the curved heel stop 340 transmits the reciprocating motion 124 to the foot. A midfoot support 330 is above the curved heel stop 340.

The midfoot support 330 transmits the force of the reciprocating motion 124 from the reciprocating medical device 102 to the foot. The quarter-pipe and pair of ridges 320 provide an indentation for the foot to be placed on the holder 300 while allowing the foot to freely move around. The pair of ridges 320 line the side of the holder 300 from the heel-rest 310 to the curved heel stop of the midfoot support 330. The quarter-pipe shape of the holder 300 may be in just the heel-rest, the curved heel stop, the midfoot support, any combination hereof, or as shown in FIG. 3, up the entire side of the holder 300 that faces the foot.

The holder 300 may be shaped to support body parts other than the foot. In one embodiment, the holder 300 may be shaped to apply reciprocating motion 124 to the back of an individual 103. The holder 300 that supports the back may be shaped such that an individual 103 may sit against the holder 300 while the holder 300 transmits reciprocating motion 124 in a direction from the back to the chest. In an exemplary embodiment, the holder 300 may be shaped to support a hand. Similar to the shape of the holder 300 shown in FIG. 3 where the holder 300 transmits reciprocating motion through the heel of a foot, the holder 300 may transmit reciprocating motion 124 through the palm of a hand.

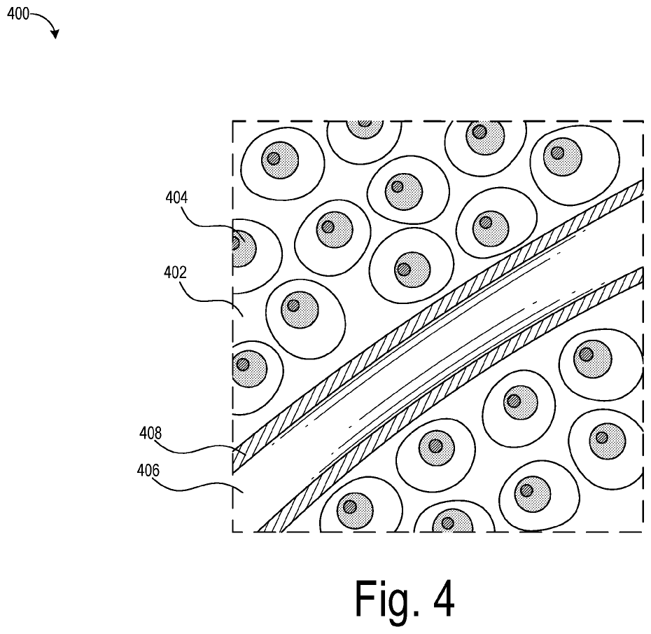

Referring to FIG. 4, FIG. 4 is an illustration 400 of interstitial fluid 402 in between cells 404 in tissue on an individual. Interstitial fluid 402 is fluid that exists between cells 404. The interstitial fluid 402 originates from fluid that is pumped through the blood stream and then traverses through the capillary walls 408 of capillary blood vessels 406.

The interstitial fluid 402 delivers nutrients to cells 404 and removes waste. The body cleans itself through the flow of interstitial fluid 402. Additionally, immune cells like macrophages, b-lymphocytes, and dendrite cells travel through the interstitial fluid 402 to find foreign proteins, bacteria, and viruses. An inflammatory response changes the permeability of the capillary walls 408 so that more fluid soaks through the capillary walls into tissues. This includes excess fluid that results from an inflammatory response such as trauma, an infection, or an allergic reaction.

Inflammation is an excess of interstitial fluid 402 in tissue. Thus, the movement of interstitial fluid 402 will have an effect on inflammation. Whether the cause is from traumatic injury or from an infection, damaged tissue gives off proteins as signals to the rest of the body to initiate an inflammatory response. The inflammatory response is regulated by the vagus nerve, which responds to oscillating motion. In particular, stimulation of the vagus nerve has been shown to suppress inflammation. Thus, oscillatory motion, which is transmitted to the body by the reciprocating medical device 102, may stimulate the vagus nerve and thus reduce inflammation. The reciprocating medical device 102 may further adjust the oscillatory motion based on feedback from the medical sensor 130 to optimize the effect on the vagus nerve to control inflammation. It may also adjust the oscillatory motion based on feedback from the medical sensor 130 to optimize the stimulation of the parasympathetic nervous response.

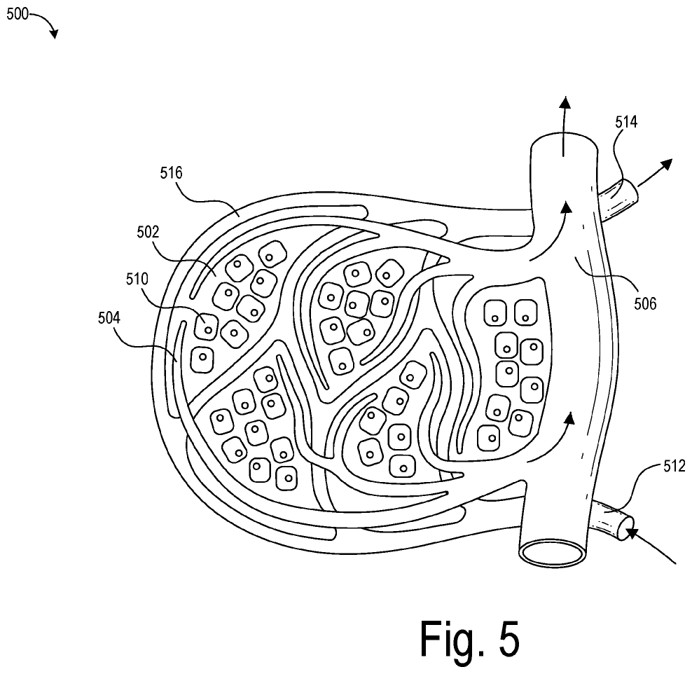

Referring to FIG. 5, FIG. 5 is an illustration 500 of interconnectivity of interstitial fluid 502 with capillary blood vessels 516 and the lymphatic system. Blood is pumped in the circulatory system through arteries 512. As the blood flows through the capillary blood vessels 516, fluid leaves the capillary blood vessels 516 where it moves to tissues and between the cells and is referred to it as interstitial fluid. The rest of the blood is pumped away through the veins 514.

As discussed above, the interstitial fluid maintains the cells 510 in tissue. The interstitial fluid 502 then drains into lymph capillaries 504 and lymph vessels 506 where it is referred to as lymph. The interstitial fluid 502, when it is in tissues and between cells, does not have a heart or the contraction of the muscle walls of blood vessels to push it into the lymphatic system. Instead, the interstitial fluid may circulate in response to muscle contraction and body movement.

The reciprocating medical device 102 imparts oscillating forces to the interstitial fluid 502 to promote it to circulate more rabidly into the lymphatic system. By moving the interstitial fluid 502, the reciprocating medical device 102 may clear out the proteins that initiate the inflammatory reflex and possibly reduce the inflammation associated with it. Additionally. some of the proteins from damaged tissue create signals that communicate with nearby cells and trigger those cells to start dividing. This initiates healing of the damaged tissue. These proteins that initiate healing may be more rapidly circulated in response to oscillating motion. Clinical studies with the reciprocating medical device 102 have shown an acceleration in healing when a patient is moved in specific combinations of frequency and amplitude.

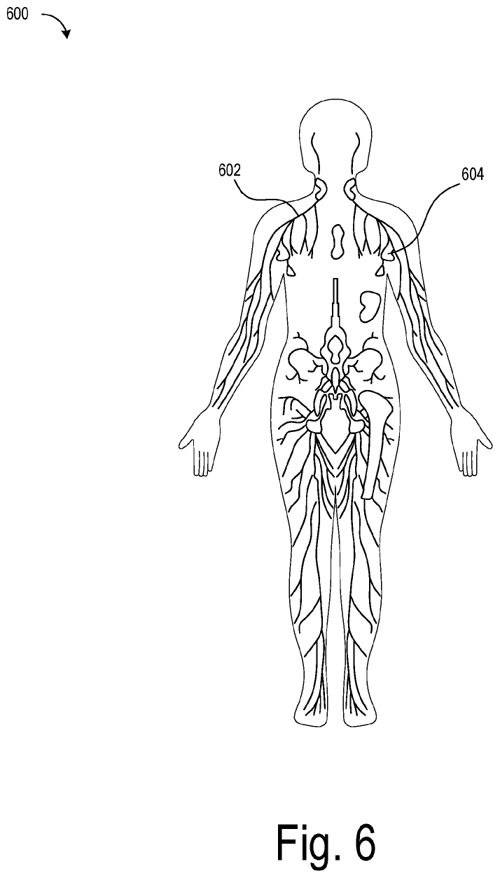

Referring to FIG. 6, FIG. 6 is an illustration 600 of a lymphatic system in an individual. The interstitial fluid is referred to as lymph as it flows through the lymphatic system. The lymph may contain immune cells, apoptotic cells, proteins, infectious organisms, and antigens. Pressure gradients control the movement of lymph through lymph vessels 602 and lymph ducts 604. Additionally, muscle contractions and body movement may facilitate lymph flow. Various valves in the lymphatic system prevent lymph from flowing backward and promote forward flow of lymph toward blood circulation.

Studies in rats and dogs have shown that lymphatic pumps increase lymph flow. Lymphatic pumps may comprise manual compression of a specific body region. For example, a lymphatic pump may comprise compressions of a body region at a rate of 20-30 compressions for two to five minutes. Lymphatic pump treatment for humans has been shown to have a positive result for fighting infections.

The reciprocating medical device 102 may similarly promote lymph flow in the lymphatic system. Like the lymphatic pump, oscillatory movement of the reciprocating medical device 102 may facilitate movement of lymph through the lymphatic system, which may aid healing and help fight infections. Further, by adjusting to a preferred frequency and amplitude, the reciprocating medical device 102 automatically optimizes the oscillatory movement to promote the best results.

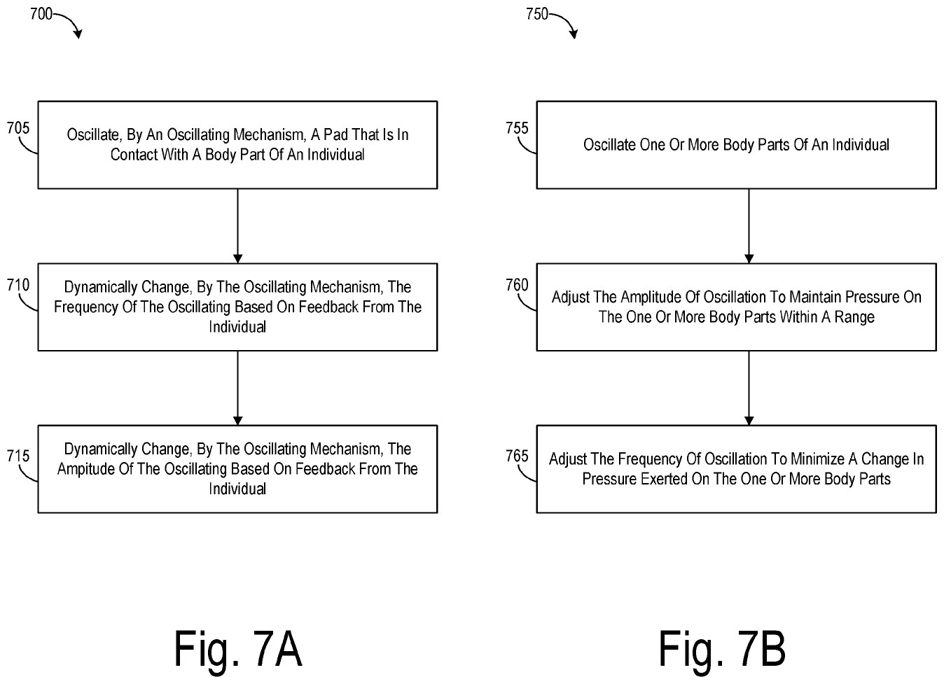

Referring to FIG. 7A, FIG. 7A is a flow diagram 700 for a process of adjusting the reciprocating motion 124 to an optimal frequency of an individual 103. The optimal frequency of an individual 103 may be the frequency of back and forth motion for which the least force is required to maintain. In various embodiments, the optimal frequency is based on a physiological response from an individual and deviates from the frequency that requires the least force to maintain. At step 705, the reciprocating medical device 102 may oscillate, by an oscillating mechanism 104, a pad that is in contact with a body part of an individual 103. The pad may be the holder 300 that is shown in FIG. 3. The oscillating mechanism 104 may transmit a reciprocating motion 124 through the pad and the body part to the rest of the individual 103. The reciprocating motion 124 may simulate the motion that is induced by a human practitioner such as a massage therapist. Just as a human practitioner adjusts a treatment to the individual 103, the reciprocating medical device 102 adjusts the reciprocating motion 124, which oscillates the individual 103, based on the individual 103.

At step 710, the reciprocating medical device 102 may dynamically change, by the oscillating mechanism 104, the frequency of the oscillating based on feedback from the sensors. The oscillating mechanism 104 may adjust the frequency to an optimal frequency of back and forth motion of the individual 103. The optimal frequency of back and forth motion may be found by measuring feedback from the sensors as the individual 103 is oscillated back and forth. The feedback sensor 116 may measure the force exerted by the holder 120 against the individual 103. Similarly, the medical sensor 130 may measure a physiological response in the individual. The frequency control module 112 may determine the optimal frequency based on measurements from the feedback sensor 116 and one or more medical sensors 130.

At step 715, the reciprocating medical device 102 may dynamically change, by the oscillating mechanism 104, the amplitude of the oscillating based on feedback from the sensors. Similar to the frequency of oscillation, the oscillating mechanism 104 may modify the amplitude of oscillation based on feedback from the sensors. The amplitude control module 110 may adjust the amplitude based on measurements from the feedback sensor 116 and one or more medical sensors 130.

Referring to FIG. 7B, FIG. 7B is a flow diagram 750 for a process of adjusting the reciprocating motion 124 to an optimal frequency of the individual 103. At step 755, the reciprocating medical device 102 may oscillate one or more body parts on an individual 103. In one embodiment, the reciprocating medical device 102 may oscillate the two feet of an individual 103. If the legs of the individual 103 are extended, the oscillation may be transmitted through the feet and locked knees to the hips and ultimately to the head as the entire body is put in motion. In various embodiments, the reciprocating medical device 102 may oscillate body parts of an individual 103 other than the feet.

At step 760, the reciprocating medical device 102 may adjust the amplitude of oscillation to maintain pressure on the one or more body parts with a range. The pressure on the one or more body parts may be measured by the feedback sensor 116, which may be a force gauge or the like. In one embodiment, the amplitude control module 110 of the oscillating mechanism 104 may adjust the crest and the trough of the amplitude separately. The crest is the point of the oscillation that is furthest toward the individual 103. The trough is the point of the oscillation that is furthest away from the individual 103. In various embodiments, the crest and trough are modified together by a single mechanism.

As the crest is the furthest point toward the individual 103, the crest is likely to be the point of the highest pressure, as measured by the feedback sensor 116 when the individual 103 is not being oscillated. However, the crest may not always have the highest pressure of all points in an oscillation because various frequencies of oscillation may produce different results. The crest may be set in various ways. In one implementation, the crest is set at the point at which the feedback sensor measures a maximum pressure. Similarly, the trough is likely to be the point of the lowest pressure, as measured by the feedback sensor 116 when the individual 103 is not being oscillated. The trough may be set at the point at which the feedback sensor 116 measures a minimum pressure. The maximum and minimum pressures may be set in various ways. In one implementation, the maximum pressure is set as the average pressure exerted when an individual 103 is pushed 1 cm without oscillation. The minimum pressure may be set as half the maximum pressure.

At step 765, the reciprocating medical device 102 may adjust the frequency of oscillation to minimize a change in pressure exerted on the one or more body parts. Like the amplitude, the frequency of oscillation may be adjusted based on measurements from the feedback sensor 116. The feedback sensor 116 may measure the pressure in various ways such as spring displacement. The frequency of oscillation may be adjusted based on various criteria to find the optimal frequency of oscillation of the individual 103. In one embodiment, the frequency may be adjusted to the frequency at which the change in pressure through one oscillation, as measured by the deviation in pressure measurement by the feedback sensor, is the lowest. In an exemplary embodiment, the frequency of oscillation is adjusted to the frequency at which the total pressure over an oscillation is the lowest. In various embodiments, the reciprocating medical device 102 may determine a frequency and amplitude at which the individual naturally oscillates, and then further adjust that frequency and amplitude based on measurements from one or more medical sensors 130.

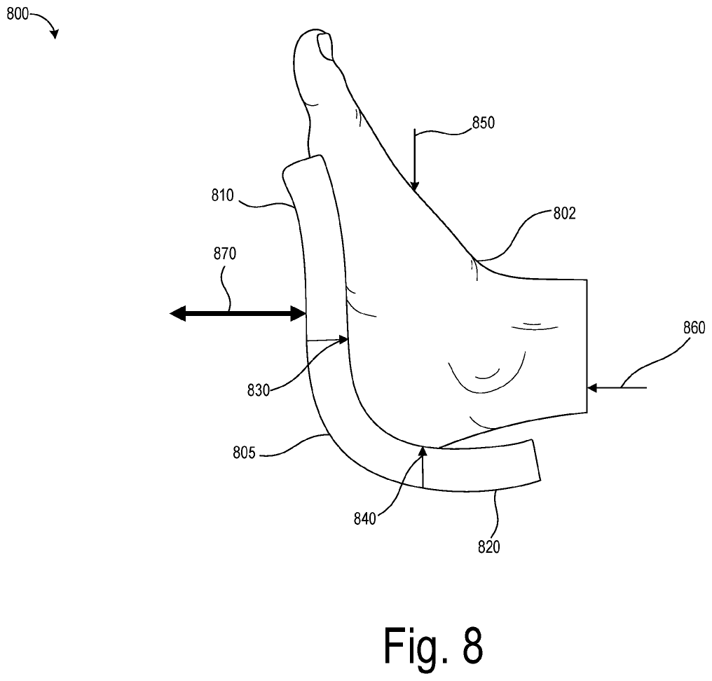

Referring to FIG. 8, FIG. 8 is an illustration 800 of a foot 802 of an individual 103 resting in the holder 805 of the reciprocating medical device 102. The holder 805 may be shaped to hold various body parts. The holder 805 shown in FIG. 8 is shaped to hold the hindfoot and midfoot portions of a foot 802. The bottom of the midfoot is in contact with the midfoot support 810. The midfoot support 810 transmits the reciprocating motion 870 to the foot 802 by pushing on the bottom of the foot 802. The heel-rest 820 supports the weight of the foot 802 when the heel of the foot 802 is pointing toward the ground.

In various embodiments, the individual 103 lies down and rests their heels in a pair of holders 805. Each holder 805 only partially covers the side of the foot 802, thus allowing the foot 802 to freely turn side-to-side by rotating about the ankle. As the individual 103 lies with one or two feet in the holder 805, the holder 805 may oscillate in a back and forth reciprocating motion 870. The reciprocating motion 870 may be divided into a push motion and a pull motion. The holder 805 transmits the force 830 of the push motion through the bottom of the foot. The push motion may cause the body to be pushed in a foot-to-head direction. The skin of the individual 103 that is in contact with a horizontal surface, may resist movement as the rest of the body moves. In various embodiments, the pull motion does not transmit any force to the foot 802. However, the force 860 of the body may keep the foot 802 in contact with the holder 805 during the pull motion. As the holder 805 is pulled from the body during the pull motion, the body may follow the holder 805 even though the holder 805 does not transmit a pulling force to the foot 802.

The force 850 of gravity may balance out against the force 840 pushing up from the heel-rest 820. The force 850 of gravity may push on the rest of the body to create friction of the body with a horizontal surface on which the body of the individual 103 is lying. The friction may prevent the individual 103 from sliding as a result of the force 830 of the push motion. As a result of the friction, which prevents the body from sliding, the force 860 of the body resists the push motion and propels the body toward the holder 805 during the pull motion.

As every body is different, the forces and distances that the body may be propelled toward the holder 805 during the pull motion may be different. Likewise, some bodies may resist movement more than others during the push motion. For those reasons, the ideal frequency and amplitude of the reciprocating motion 870 may be different for every individual 103. The reciprocating medical device 102 may determine the ideal frequency and amplitude by measuring the force 830 of the contact between the foot 802 and the holder 805 and adjusting the frequency and amplitude based on the force of contact.

Referring to FIG. 9, FIG. 9 is an illustration of an embodiment of the holder 900 of the reciprocating medical device that holds two feet 902. In various embodiments, the holder 900 may hold a body part by allowing the body part to rest within the holder 900. In an exemplary embodiment, the holder 900 may be a pad that presses against a body part. In the embodiment shown in FIG. 9, the holder 900 is shaped to allow two feet to rest by placing the heels of the feet in the heel-rests 310 of the holder 900. In various embodiments, the holder 900 may be shaped to support the back of an individual 103 as the individual 103 sits against the holder 900.

The holder 900 may be attached to the actuator rod 118, which transmits the reciprocating motion 124 to the holder 900. As shown in FIG. 9, a platform 908, which is transparent in FIG. 9 for the purpose of showing a more complete view of the holder 900, provides connection points for foot holders 904. The actuator rod 118 may also be connected to the platform 908. The actuator rod 118 is the part of the actuator 108 that provides the force to push and pull for the reciprocating motion 124.

The holder 900 may move back and forth with the actuator rod 118 as the oscillating mechanism 104 transmits reciprocating motion 124 to the holder 900 through the actuator rod 118. The platform 908 allows the motion of the actuator rod 208 to be transmitted to objects that are connected to the platform 908. As shown in FIG. 9, the platform 908 is connected to two foot holders 904. The foot holders 904 are connected to the platform 908 by compliant rods 906. The compliant rods 906 may be configured to connect the foot holders 904 at various angles regardless of the angle of the platform 908. For example, the compliant rods 906 may connect the foot holders 904 to the platform 908 such that feet 902, which are resting in the foot holders 904 may have their toes pointed in a comfortable direction for the individual 103. The compliant rods 906 may be flexible and allow a limited movement that deviates from the motion of the actuator rod. In various embodiments, the compliant rods 906 only allow a deviation that is perpendicular to the motion of the actuator rod. The deviation, as the actuator oscillates, may result in the foot holders 904 moving in an elliptical motion instead of a linear motion.

In an exemplary embodiment, the compliant rods 906 may be made of a material that allows the compliant rods 906 to only flex linearly. For example, the compliant rods 906 may only flex along an axis that goes along the length of the compliant rods 906. Further, the flexibility of the compliant rods 906 may vary between the individual compliant rods 906. Thus, an allowable deviation of the compliant rods 906 may be constrained based on the arrangement and flexibility of the individual compliant rods 906.

As shown in FIG. 9, the foot holders 904 allow the feet of the individual 103 to freely move side to side and pull away from the foot holders 904. The foot holders 904 may partially envelope the sides of the feet 902 to provide stability for the individual 103. However, the feet 902 of the individual 103 may still freely move side to side despite the sides of the foot holders 904 partially enveloping the side of the feet 902.

The foot holders 904 are configured to comfortably provide a reciprocating pushing force to the feet 902. The actuator rod 118 may push the platform 908 such that a pushing force is transmitted in the feet 902 to head direction. The actuator rod 118 may also pull the platform such that the foot holders 904 are pulled away from the feet 902. The feet 902 however, are not pulled by the foot holders 904. Instead, the tendency of the body of the individual 103 to remain in one place as the individual 103 lies on a horizontal surface may cause the feet 902 to follow the foot holders 904 as the foot holders 904 are pulled away from the feet 902.

The holder 900 may be shaped to hold various body parts other than the feet 902. For example, the holder 900 may be shaped to provide a reciprocating motion 124 to the back of the hips of the individual 103 as the individual 103 is in a sitting position. In the example, the holder 900 may be a flat pad that comfortably provides a pushing motion to the hips of an individual 103. Similar to the way the feet 902 of the individual 103 follow the foot holders 904 as the foot holders 904 are pulled away from the feet 902, the hips of the individual 103 may follow the holder 900 as the holder 900 is pulled away from the hips.

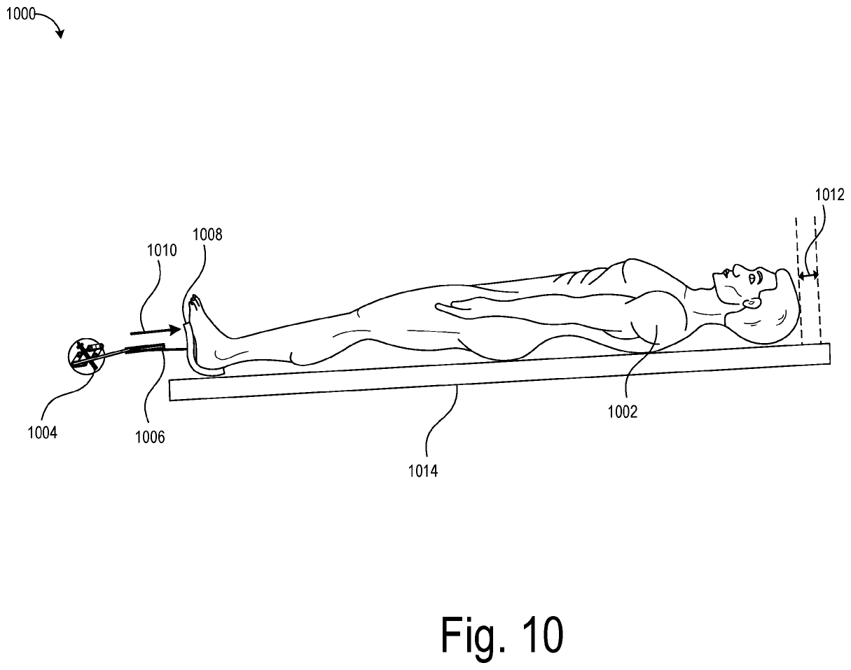

Referring to FIG. 10, FIG. 10 is an illustration 1000 of a reciprocating medical device 102 that can transfer reciprocating motion 124 to an individual 1002. The reciprocating medical device 102 may have an oscillating mechanism 1004 that oscillates to produce a reciprocating motion 1012 in the individual 1002. The oscillating mechanism 1004 may convert an oscillating rotation to a linear oscillation. The oscillating mechanism may be connected to an actuator rod 1006, which transmits the oscillation in a linear direction 1010. As shown in FIG. 10, the actuator rod 1006 transmits the oscillation in a direction 1010 from the feet to the head of the individual 1002 as the individual 1002 is lying on a horizontal surface 1014.

The actuator rod 1006 transmits the reciprocating motion 1012 to a holder 1008. The holder 1008 may support various body parts. As shown in FIG. 10, the holder 1008 is supporting the feet of the individual 1002. The force from the reciprocating medical device 102 is transmitted to the feet of the individual 1002 as the holder 1008 pushes the individual 1002 in the direction 1010 from the feet to the head of the individual 1002. If, as shown in FIG. 10, the knees of the individual 1002 are locked, the pushing force from the holder 1008 may propagate through the body of the individual 1002 to push the head of the individual 1002 in the direction 1010 from feet to head.

The feedback sensor 116 may be in various parts of the reciprocating medical device 102. The feedback sensor 116 may be a force gauge in the holder 1008 whereby the feedback sensor 116 can measure the force of the contact between the feet and the holder 1008. Alternatively, the feedback sensor 116 may be in the oscillating mechanism 704 whereby the feedback sensor can measure the force of the actuator rod 1006 pushing on the holder 1008. In various embodiments, one or more medical sensors 130 provide physiological measurements of the individual 1002 to the reciprocating medical device 102.

The controller 106 may adjust the amplitude and frequency of the oscillating mechanism 1004 based on the measurements of the feedback sensor 116 and/or medical sensor(s) 130. In various embodiments, the oscillating mechanism 1004 creates the reciprocating motion 1012 by rotating the rotor 202 repeatedly in one direction. In an exemplary embodiment, the oscillating mechanism 1004 creates the reciprocating motion 1012 by rotating the rotor 202 back and forth by repeatedly reversing the rotation of the rotor 202. The controller 106 may adjust the frequency to minimize the force, as measured by the feedback sensor 116, over the course of one oscillation. The controller 106 may adjust the amplitude to keep the force, as measured by the feedback sensor 116, within a minimum and maximum range over the course of one oscillation. Various other criteria, such as the physiological measurements from the one or more medical sensors 130, may be used by the controller 106 to adjust the frequency and amplitude of the reciprocating motion 1012.

The horizontal surface 1014 may be various objects or materials. Ideally, the horizontal surface 1014 is comfortable for the individual 1002 to lie on as the reciprocating motion 1012 is transmitted to the individual 1002. The horizontal surface may influence the optimal frequency of the individual 1002 because the horizontal surface provides the friction that allows the individual 1002 to return back to the original position of the individual 1002 after the reciprocating medical device 102 pushes the individual 1002.

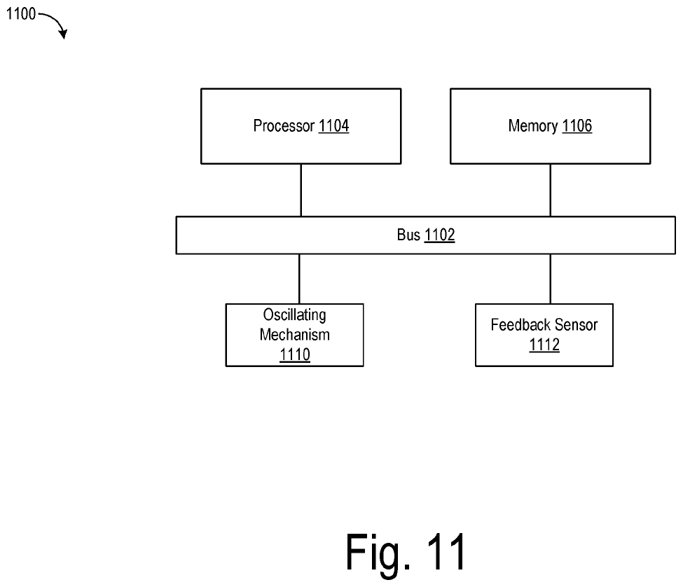

Referring to FIG. 11, FIG. 11 is a block diagram of a computer system 1100 that may be implemented in the various embodiments of the controller 106 for the reciprocating medical device 102. The controller 106 determines the amplitude and frequency of the oscillating mechanism 1110 based on measurements from the feedback sensor 1112. The controller 106 may be a single computer system 1100, may be co-located, may be a cloud-based computer system 1100, or the like.

The computer system 1100 may include a bus 1102. The bus 1102 connects the various components of the computer system 1100 such that the various components may communicate with one another. The computer system 1100 may include a processor 1104 that is connected to the bus 1102. The processor 1104 performs computations and executes instructions that are transmitted to the processor 1104. The processor 1104 may be an integrated circuit such as a central processing unit (“CPU”). Instructions are transmitted to the processor 1104 by a memory 1106 through the bus 1102. After the processor 1104 executes instructions, the executed instructions are passed back to the memory 1106. As such, the memory 1106 handles all data that is passed to and from the processor 1104. Various types of memory 1106 are random access memory (“RAM”) and read only memory (“ROM”).

The memory 1106 may send instructions, that when executed, operate the oscillating mechanism 1110. The instructions that the memory 1106 sends to the oscillating mechanism 1110 may have been processed by the processor 1104. The oscillating mechanism 1110 may start, stop, vary the frequency, and vary the amplitude of reciprocating motion 124 that is produced by the oscillating mechanism 1110. The memory 1106 may also receive measurements from the feedback sensor 1112. The memory 1106 may transmit the measurements from the feedback sensor 1112 to the processor 1104. The processor 1104 may process the measurements and create instructions that are sent back to the memory 1106. The memory 1106 may transmit the processed instructions to the oscillating mechanism 1110 to modify the operation of the oscillating mechanism 1110 or keep the oscillating mechanism 1110 operation unchanged. The memory 1106 and processor 1104 may execute a program that finds the optimal frequency of the individual 103 based on the measurements from the feedback sensor 1112. Similarly, the memory 1106 and processor 1104 may execute a program that determines the ideal amplitude for the individual 103. The computer system 1100 may be configured such that an individual 103 may manually set the frequency and amplitude. Alternatively, the individual 103 may restrict the frequencies and amplitudes at which the oscillating mechanism 1110 may operate.

Various embodiments of the disclosed subject matter herein may be made. All of the various embodiments are intended to be included in the scope of the disclosed subject matter. The various embodiments described herein may be practiced in many ways. The description of the various embodiments should not be interpreted as restricting the disclosed subject matter. Instead, the scope of the disclosed subject matter should be interpreted in accordance with the appended claims.

1. A medical device, the medical device comprising:
a holder that can hold one or more body parts of an individual;
an oscillating mechanism that can transmit an oscillating force to the holder;
one or more sensors that provide information about the individual;
one or more compliant components that are configured to allow movement of the one or more body parts that deviates from a movement of oscillation;
wherein the oscillating mechanism can dynamically change a frequency of oscillation based on feedback from the one or more sensors; and
wherein the oscillating mechanism dynamically changes an amplitude of the oscillation based on feedback from the one or more sensors.

2. The medical device of claim 1, wherein the one or more compliant components are configured to allow the one or more body parts to deviate from a motion of oscillation in a direction that is perpendicular to the movement of oscillation.

3. The medical device of claim 2, wherein at least one of the one or more compliant components comprise one or more rods that connect the holder to the oscillating mechanism; and
wherein the one or more rods are flexible.

4. The medical device of claim 1 wherein the oscillating mechanism is configured to adjust the frequency of oscillation of the oscillating mechanism to an optimal frequency of the individual based on the feedback.

5. The medical device of claim 4, wherein the feedback from the one or more sensors is a force of a contact between the individual and the oscillating mechanism; and
wherein the oscillating mechanism is configured to adjust the frequency of oscillation to the optimal frequency of the individual by minimizing the force of the contact between the individual and the oscillating mechanism.

6. The medical device of claim 4, wherein the feedback comprises one or more physiological measurements of the individual from one or more medical sensors.

7. The medical device of claim 5, wherein at least one of the one or more compliant components comprises a heel holder that is shaped to apply pressure to a heel of the one or two feet and allow the one or two feet to freely rotate about ankles of the one or two feet.

8. A medical device, the medical device comprising:
a pad that is shaped to rest against one or more body parts of an individual;
one or more sensors that provide information about the individual;
an oscillating mechanism that can transmit an oscillating force to the pad as the oscillating mechanism oscillates; and
wherein the oscillating mechanism can automatically adjust a frequency of oscillation.

9. The medical device of claim 8, wherein the oscillating mechanism can automatically adjust an amplitude of oscillation.

10. The medical device of claim 9 wherein the oscillating mechanism is configured to adjust the frequency of oscillation to minimize a force that is measured from the one or more sensors.

11. The medical device of claim 8, wherein the oscillating mechanism automatically adjusts an amplitude of oscillation to maintain a contact with the individual as the oscillating mechanism oscillates.

12. The medical device of claim 8:
wherein the pad is further shaped to support a heel portion of one or two feet; and
wherein the pad allows the one or two feet to rotate about ankles of the one or two feet freely while the one or two feet are supported by the pad.

13. The medical device of claim 12, further comprising one or more compliant rods that connect a holder to the oscillating mechanism; and
wherein the one or more compliant rods are configured to allow the feet to deviate from a movement of oscillation.

14. The medical device of claim 13:
wherein the oscillating mechanism is a linear actuator;
further comprising a force feedback sensor on the linear actuator; and
further comprising one or more medical sensors that measure a physiological response in the individual.

15. A method of providing reciprocating movement to an individual, the method comprising:
oscillating, by an oscillating mechanism, a pad that is in contact with a body part of an individual;
wherein the oscillating mechanism can dynamically change a frequency of the oscillating based on feedback from one or more sensors embedded in a device, which provide information about the individual;
wherein the oscillating mechanism can dynamically change an amplitude of the oscillating based on the feedback; and
wherein the pad is configured to allow the body part a limited movement in a direction that deviates from a direction of the oscillating.

16. The method of claim 15, wherein the pad is further configured to support one or two feet of the individual.

17. The method of claim 16, wherein a force that is transmitted from the oscillating mechanism is directed in a direction from the one or two feet of the individual through the center of mass of the individual.

18. The method of claim 15, wherein the oscillating mechanism is configured to adjust the frequency of the oscillating of the oscillating mechanism to an optimal frequency of the individual based on the feedback.

19. The method of claim 18, wherein the feedback comprises one or more physiological measurements of the individual from one or more medical sensors.

20. The method of claim 19:
wherein the feedback further comprises a force of a contact between the individual and the oscillating mechanism;
wherein the oscillating mechanism is configured to adjust the frequency of the oscillating to a natural frequency of the individual by minimizing the force of the contact between the individual and the oscillating mechanism;
wherein the oscillating mechanism is further configured to further adjust the frequency of oscillation from the natural frequency to the optimal frequency based on the one or more physiological measurements; and
wherein a holder is shaped to apply pressure to the heels of the one or two feet and allow the one or two feet to freely rotate about ankles of the one or two feet.
